(19) United States
(12) Patent Application Publication
(10) Pub. No.: US 2012/0162565 A1
(43) Pub. Date: Jun. 28, 2012

(54) LIQUID CRYSTAL DISPLAY DEVICE

(75) Inventors: Won Il Lee, Cheonan-si (KR); Jin-Seok Jang, Asan-si (KR); Myeong-An Min, Asan-si (KR)

(73) Assignee: SAMSUNG MOBILE DISPLAY CO., LTD., Yongin-si (KR)

(21) Appl. No.: 13/207,043

(22) Filed: Aug. 10, 2011

(30) Foreign Application Priority Data
Dec. 27, 2010 (KR) 10-2010-0135635

(51) Int. Cl. G02F 1/1335

(52) U.S. Cl. 349/58; 349/62

(57) ABSTRACT

A liquid crystal display device includes a display panel structure, and a back light unit configured to supply light to the display panel structure, wherein the display panel structure includes a light shield configured to shield some of light supplied to the display panel structure, and the light shield is formed over an edge portion of the display panel structure.

### CROSS-REFERENCE TO RELATED APPLICATIONS

This U.S. non-provisional patent application claims priority under 35 U.S.C. §119 of Korean Patent Applications No. 10-2010-0135635, filed on Dec. 27, 2010, the entire contents of which are hereby incorporated by reference.

### BACKGROUND

The present disclosure herein relates to a liquid crystal display device.

Due to lightweight, slimness and low power consumption characteristics, liquid crystal display devices have been widely used in small-sized electronic devices such as mobile phones, PDA as well as in televisions, computers and the like. As liquid crystal display devices are used in various electronic devices and industrial fields, requirements on liquid crystal display devices with high reliability are increasing.

Generally, a liquid crystal display device is provided with a liquid crystal display panel displaying an image using light, an optical sheet, and a back light unit generating light to supply the generated light to the liquid crystal display panel. The reliability of the liquid crystal display panel may be lowered due to detachment of the optical sheet and light leakage from the back light unit.

### SUMMARY

The present disclosure provides a liquid crystal display device with high reliability.

The present disclosure also provides a liquid crystal display device which can minimize light exposure phenomenon.

The present disclosure also provides a liquid crystal display device which can minimize detachment phenomenon of an optical sheet.

Embodiments of the inventive concept provide liquid crystal display devices including a display panel structure, and a back light unit is configured to supply light to the display panel structure, wherein the display panel structure includes a light shield configured to shield a portion of the light supplied to the display panel structure, and the light shield is formed over an edge portion of the display panel structure.

In some embodiments, the display panel structure may include a polarizer, a lower substrate and an upper substrate that are stacked sequentially, and wherein the polarizer may include the light shield.

In other embodiments, the polarizer may include a first surface facing the lower substrate, and a second surface opposing the first surface, and wherein the light shield may be formed over the second surface of the polarizer.

In still other embodiments, the light shield may be formed over an edge portion of the second surface of the polarizer.

In even other embodiments, the light shield may be formed by black-printing the edge portion of the second surface of the polarizer.

In yet other embodiments, the display panel structure may include a polarizer, a lower substrate and an upper substrate that are stacked sequentially, and wherein the lower substrate may include the light shield.

In further embodiments, the lower substrate may include a first surface facing the polarizer, and a second surface opposing the first surface, and the light shield may be formed over the first surface of the lower substrate.

In still further embodiments, the first surface of the lower substrate may include a light shielding area where the light shield is formed, and a light transmission area surrounded by the light shield, and wherein the polarizer may be disposed over the light transmission area of the first surface of the lower substrate.

In even further embodiments, the light shield may be formed over an edge portion of the first surface of the lower substrate.

In yet further embodiments, the light shield may be formed by black-printing the edge portion of the first surface of the lower substrate.

In other embodiments, the above liquid crystal display devices may further include a mold frame including an upper surface supporting the display panel structure and surrounding the back light unit, and an adhesive member disposed over the upper surface of the mold frame to adhere the mold frame to the display panel structure.

In still other embodiments, the back light unit may include an optical sheet which may be spaced apart from the adhesive member.

In even other embodiments of the inventive concept, liquid crystal display devices include a display panel structure, a mold frame including an upper surface supporting the display panel structure, and an adhesive member disposed between the upper surface of the mold frame and the display panel structure, and adhering the mold frame to the display panel structure, wherein the display panel structure includes a light shield contacting the adhesive member.

In yet other embodiments, the above liquid crystal display devices may further include a back light unit configured to supply light to the display panel structure and surrounded by the mold frame, wherein the back light unit may include a light source, and an optical sheet through which the light generated from the light source transmits, and wherein the adhesive member may be spaced apart from the optical sheet.

In further embodiments, the light shield may include a first portion contacting the adhesive member, and a second portion overlapping the optical sheet.

In still further embodiments, the second portion may not contact the adhesive member.

In even further embodiments, the display panel structure may include a first polarizer, a second polarizer, and a thin film transistor substrate and a color filter substrate between the first polarizer and the second polarizer, and wherein the light shield may be formed over a surface of the first polarizer facing the upper surface of the mold frame, and the first polarizer may be adhered to the mold frame by the adhesive member.

In yet further embodiments, the display panel structure may include a first polarizer, a second polarizer, and a thin film transistor substrate and a color filter substrate between the first polarizer and the second polarizer, and the light shield may be formed over a surface of the lower substrate facing the upper surface of the mold frame, and the lower substrate may be adhered to the mold frame by the adhesive member.

### BRIEF DESCRIPTION OF THE DRAWINGS

The accompanying drawings are included to provide a further understanding of the inventive concept, and are incorporated in and constitute a part of this specification. The drawings illustrate embodiments of the inventive concept and, together with the description, serve to explain principles of the inventive concept. In the drawings:

FIG. 1 is an exploded perspective view of a liquid crystal display device according to an embodiment of the inventive concept;

FIG. 2A is a cross-sectional view taken along line I-I′ of FIG. 1, for describing a light shield of a liquid crystal display device according to an embodiment of the inventive concept;

FIG. 2B is a perspective view of a polarizing plate included in a liquid crystal display device according to an embodiment of the inventive concept;

FIG. 3A is a cross-sectional view taken along line I-I′ of FIG. 1, for describing a light shield included in a liquid crystal display device according to another embodiment of the inventive concept; and

FIG. 3B is a perspective view of a lower substrate included in a liquid crystal display device according to another embodiment of the inventive concept.

### DETAILED DESCRIPTION OF THE EMBODIMENTS

The above and other aspects, features and advantages of the present invention will be better understood from the following description of preferred embodiments taken in conjunction with the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art.

In the drawings, the sizes, thicknesses and the like of elements are exaggerated for clarity of illustration. Also, though terms like a first, a second, and a third are used to describe various regions and layers in various embodiments of the present invention, the regions and the layers are not limited to these terms. These terms are used only to discriminate one region or layer from another region or layer. An embodiment described and exemplified herein includes a complementary embodiment thereof. As used herein, the term ‘and/or’ includes any and all combinations of one or more of the associated listed items. Like reference numerals refer to like elements throughout.

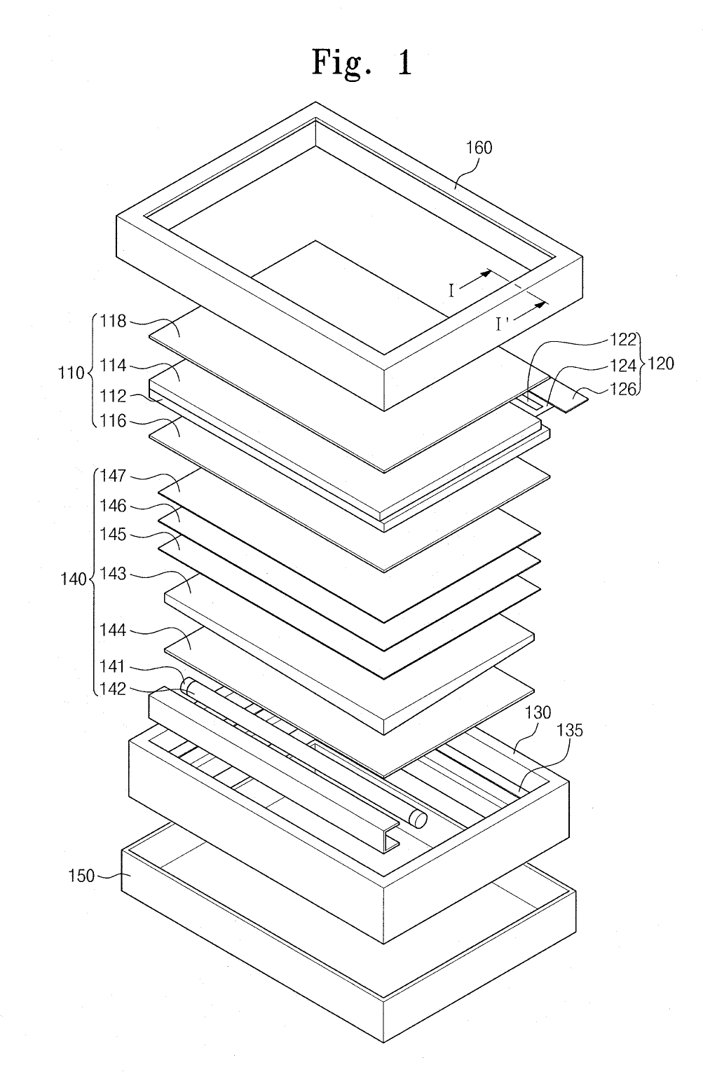

A liquid crystal display device according to an embodiment of the inventive concept will be described below. FIG. 1 is an exploded perspective view of a liquid crystal display device according to an embodiment of the inventive concept.

Referring to FIG. 1, a liquid crystal display device according to an embodiment of the inventive concept may include a display panel structure 110, a panel driver 120, a mold frame 130, a back light unit 140, a bottom chassis 150, and a top chassis 160.

The display panel structure 110 may include a lower substrate 112, an upper substrate 114, a first polarizer 116, and a second polarizer 118. The first polarizer 116, the lower substrate 112, the upper substrate 114 and the second polarizer 118 are sequentially stacked such that the lower substrate 112 and the upper substrate 114 are disposed between the first polarizer 116 and the second polarizer 118. The display panel structure 110 may include a liquid crystal layer interposed between the lower substrate 112 and the upper substrate 114.

The lower substrate 112 may include a plurality of gate lines extending in a direction, a plurality of data lines crossing the plurality of gate lines, and thin film transistors formed at crossing regions between the plurality of gate lines and the plurality of data lines. The upper substrate 114 may be a color filter substrate on which a color filter array is formed. The lower substrate 112 and the upper substrate 114 may include a plurality of pixel cells including the thin film transistors.

The first polarizer 116 includes a transmission axis of a first direction, which causes incident light to be polarized in the first direction. The second polarizer 118 includes a transmission axis of a second direction, which causes incident light to be polarized in the second direction. The second direction may cross the first direction. The second direction may be perpendicular to the first direction.

The panel driver 120 may include a drive circuit 122 driving the lower substrate 112 of the display panel structure 110, a control board 126 transferring a signal to the drive circuit 122, and a drive interconnection line 124 connecting the drive circuit 122 and the control board 126. The driver circuit 122 may include a gate driver sequentially supplying a gate-on voltage to the plurality of gate lines of the lower substrate 112, and a data driver supplying a data voltage to the plurality of data lines of the lower substrate 112. The drive circuit 122 is mounted on the drive interconnection line 124 prepared in the form of a tape carrier package (TCP) and thus may be connected to the lower substrate 112. Alternatively, the drive circuit 122 may be mounted directly on the lower substrate 112 in the form of a chip on glass (COG).

The control board 126 may include a timing controller transferring a timing signal to the gate driver and the data driver, and a power. The power may supply gate-on/off voltage to the gate driver and supply data voltage to the data driver. The control board 126 may be disposed on a bottom surface of the bottom chassis 150. The drive interconnection line 124 may cover some of an outer surface of the bottom chassis 150 in order to connect the control board 126 disposed on the bottom surface of the bottom chassis 150 to the drive circuit 122 disposed on the lower substrate 112.

The back light unit 140 may include at least one light source 141, a light source holder 142, a light guide plate 143, a reflection sheet 144, and optical sheets 145, 146, 147. The light source 141 may generate light to supply the generated light to a light-incident side portion of the light guide plate 142. The light source 141 may be a lamp or a light emitting diode (LED). The light source holder 142 may make the light generated from the light source 141 to be incident into the light guide plate 143. The light guide plate 143 may make the light generated from the light source 141 to be incident into the display panel structure 110. The reflection sheet 144 may reflect the light supplied downwardly from the light guide plate 143 toward the display panel structure 110 so that light use efficiency may be enhanced. The light guide plate 143 may be formed of a transparent material in order to minimize light loss.

The optical sheets 145, 146, 147 may include a diffusion sheet 145, a prism sheet 146 and a protection sheet 147. The diffusion sheet 145 may diffuse the light at a wider angle supplied from the light guide plate 143. By doing so, generation of a bright line and a dark line may be minimized. The prism sheet 146 may include vertical and horizontal prism sheets focusing incident light in vertical and horizontal directions, respectively. The protection sheet 147 may minimize defects or damages such as scratch and the like during the transfer of the back light unit 140.

The mold frame 130 may support the display panel structure 110 and enclose the back light unit 140. The mold frame 130 may be received by the bottom and top chassis 150 and 160. An adhesive member 135 adhering the display panel structure 110 to the mold frame 130 may be disposed on an inner surface of the mold frame 130.

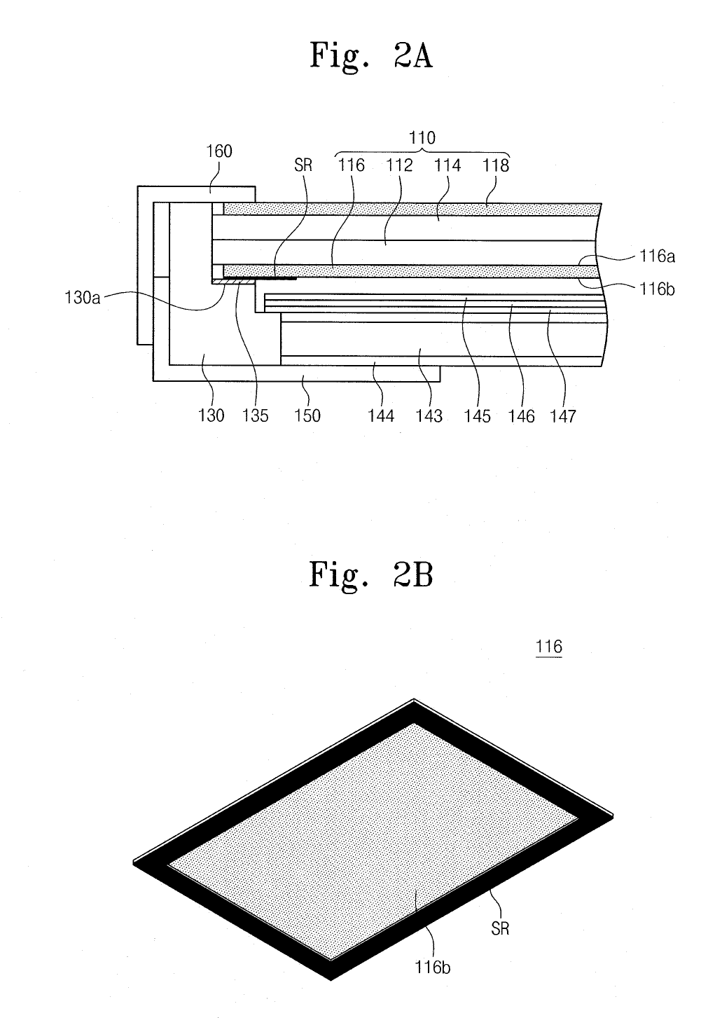

The display panel structure 110 may include a light shield contacting the adhesive member 135. The light shield may shield some of the light generated from the back light unit 140, which will be described with reference to FIGS. 2A and 2B.

FIGS. 2A and 2B are provided for describing a light shield included in a liquid crystal display device according to an embodiment of the inventive concept, and particularly, FIG. 2A is a cross-sectional view taken along line I-I′ of FIG. 1, and FIG. 2B is a perspective view of a polarizing plate included in a liquid crystal display device according to an embodiment of the inventive concept.

Referring to FIGS. 2A and 2B, the first polarizer 116 may include a first surface 116a contacting the lower substrate 112, and a second surface 116b opposing the first surface 116a. The second surface 116b may be positioned closer to the optical sheets 145, 146, 147 than the first surface 116a. A light shield SR may be formed on the second surface 116b of the first polarizer 116. Light that is incident into the light shield SR may not transmit the first polarizer 116.

The light shield SR may be formed by black-printing the second surface 116b of the first polarizer 116. For example, after the second surface 116b of the first polarizer 116 is black-printed, the first polarizer 116 may be disposed on a rear surface of the lower substrate 112. Alternatively, after the first polarizer 116 is disposed on the rear surface of the lower substrate 112, the second surface 116b of the first polarizer 116 may be black-printed.

The light shield SR may be disposed on an edge of the second surface 116b of the first polarizer 116. The light shield SR may include a plurality of segments extending, on edge portions adjacent to respective sides of the second surface 116b of the first polarizer 116, along the respective sides. For example, when the lower substrate 112 has a rectangular shape, the light shield SR may include four segments extending, on edge portions adjacent to the four sides of the lower substrate 112, along the four sides, respectively. The respective segments may have substantially the same width and extend along the respective sides.

The first polarizer 116 may include a light shielding portion on which the light shield SR is formed, and a light transmission region surrounded by the light shield SR. The light transmission region may be a portion of the first polarizer 116 where the light shield SR is not formed. In the first polarizer 116, the area occupied by the light transmission portion may be wider than that occupied by the light shielding portion. Among the light which transmits the optical sheets 145, 146, 147 and then is incident into the first polarizer 116, the light which is incident into the light shielding portion where the light shield is formed may not transmit the first polarizer 116, and the light which is incident into the light transmission portion may transmit the first polarizer 116. The light which is incident into the light transmission portion and transmits the first polarizer 116 may be incident into the lower and upper substrates 112 and 114.

That is, the light shield SR formed on the edge portions of the second surface 116b of the first polarizer 116 may partially shield the light which is incident into the edge portions of the display panel structure 110. Therefore, light leakage phenomenon which may be caused by the light incident into the edge portions of the display panel structure 110 may be minimized and thus a high reliability liquid crystal display device may be provided.

If the light shield SR is not formed, the light which is incident into the edge portions of the display panel structure 110 may be incident into a pixel region where the pixel cells of the display panel structure 110 are formed, and/or a peripheral region where the pixel cells are not formed. The light which is incident into the peripheral region of the display panel structure 110 may transmit the display panel structure 110 and then may be leaked to the outside from the liquid crystal display device. Such light leakage may lower reliability of the liquid crystal display device.

However, as aforementioned, according to the embodiment of the inventive concept, the light which is incident into the edge portions of the display panel structure 110 may be shielded by the light shield SR, so that light leakage phenomenon may be minimized.

The mold frame 130 may include a support upper surface 130a supporting the display panel structure 110. The adhesive member 135 is disposed on the support upper surface 130a so that the display panel structure 110 may be adhered to the support top surface 130a of the mold frame 130.

The adhesive member 135 may overlap the light shield SR formed on the second surface 116b of the first polarizer 116. The adhesive member 135 may directly contact the light shield SR of the first polarizer 116. The light shield SR may include a first portion contacting the adhesive member 135, and a second portion. The second portion may be a remaining portion of the light shield SR except for the first portion. The second portion of the light shield SR may be spaced apart from and may overlap the optical sheets 145, 146, 147 and the light guide plate 142.

The adhesive member 135 may contact the light shield SR of the first polarizer 116, and may be spaced apart from the optical sheets 145, 146, 147. Therefore, detachment of the optical sheets 145, 146, 147 may be prevented so that a high reliability liquid crystal display device may be provided.

If the adhesive member 135 contacts the optical sheets 145, 146, 147, detachment of the optical sheets 145, 146, 147 may be generated due to the difference in contraction between the optical sheets 145, 146, 147 so that reliability of the liquid crystal display device may be lowered.

However, as aforementioned, according to the embodiment of the inventive concept, the adhesive member 135 contacts the light shield SR formed on the first polarizer 116 to fix the display panel structure 110 to the mold frame 130, but does not contact the optical sheets 145, 146, 147. Therefore, detachment phenomenon of the optical sheets 145, 146, 147 may be prevented.

Also, as aforementioned, the light shield SR may be formed on the edge portions of the second surface 116b of the first polarizer 116 to shield some of the light incident into the edge portions of the display panel structure 110. Therefore, detachment phenomenon of the optical sheets 145, 146, 147 may be prevented and the light leakage phenomenon may be minimized, so that a high reliability liquid crystal display device may be provided.

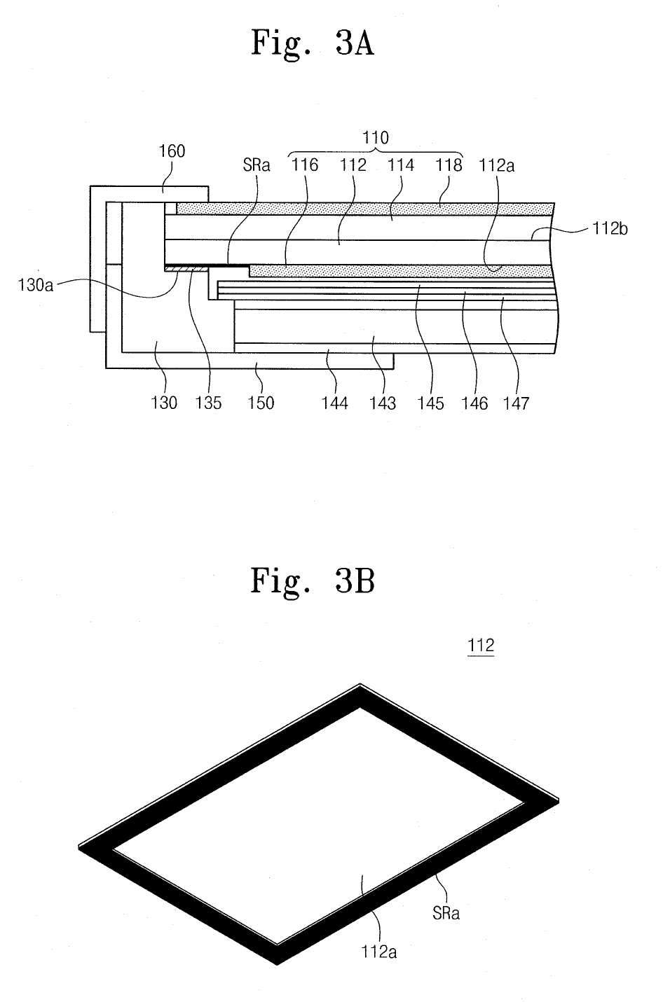

In the foregoing embodiment, the light shield SR is formed on the first polarizer 116. Alternatively, the light shield may be formed on the lower substrate 112, which will be described with reference to FIGS. 3A and 3B.

FIGS. 3A and 3B are provided for describing a light shield included in a liquid crystal display device according to another embodiment of the inventive concept, and particularly, FIG. 3A is a cross-sectional view taken along line I-I′ of FIG. 1, and FIG. 3B is a perspective view of a lower substrate included in a liquid crystal display device according to an embodiment of the inventive concept.

Referring to FIGS. 3A and 3B, the display panel structure 110, the panel driver 120, the mold frame 130, the back light unit 140, the bottom chassis 150, and the top chassis 160 which are described in FIGS. 2A and 2B may be provided. The lower substrate 112 may include a first surface 112a contacting the first polarizer 116, and a second surface 112b opposing the first surface 112a. The first surface 112a may be close to the optical sheets 145, 146, 147, and the second surface 112b may be close to the second polarizer 118. A light shield SRa may be formed on the first surface 112a of the lower substrate 112.

The light shield SRa may be formed by black-printing the first surface 112a of the lower substrate 112. For example, after gate lines, data lines and thin film transistors are formed on the second surface 112b of the lower substrate 112, the light shield SRa may be formed by black-printing the first surface 112a of the lower substrate 112. Alternatively, after the light shield SRa is formed by black-printing the first surface 112a of the lower substrate 112, the gate lines, the data lines and the thin film transistors may be formed on the second surface 112b of the lower substrate 112.

The light shield SRa may be formed on an edge of the first surface 112a of the lower substrate 112. The light shield SRa may include a plurality of segments extending, on edge portions adjacent to respective sides of the first surface 112a of the lower substrate 112, along the respective sides. For example, when the lower substrate 112 has a rectangular shape, the light shield SRa may include four segments extending, on edge portions adjacent to the four sides of the lower substrate 112, along the four sides, respectively. The respective segments may have substantially the same width and extend along the respective sides.

The first surface 112a of the lower substrate 112 may include a light shielding area on which the light shield SRa is formed, and a light transmission area surrounded by the light shield SRa. The light transmission area may be a portion of the first surface 112a of the lower substrate 112 where the light shield SRa is not formed. In the first surface 112a of the lower substrate 112, the area occupied by the light transmission area may be wider than that occupied by the light shielding area.

The first polarizer 116 may be disposed on the light transmission area. In this case, the light shield SRa may be formed on the first surface 112a of the lower substrate 112 which is not covered by the first polarizer 116. Alternatively, the first polarizer 116 may be disposed such that the edge portions of the first polarizer 116 overlap the light shield Sra. In this case, some portion of the light shield Sra may be covered by the first polarizer 116.

Among the light which transmits the optical sheets 145, 146, 147 and/or the first polarizer 116 and then is incident into the lower substrate 112, the light which is incident into the light shielding area where the light shield SRa is formed may not transmit the first surface 112a of the lower substrate 112, and the light which is incident into the light transmission area may transmit the first surface 112a of the lower substrate 112. Due to this, the light which is incident into the edge portions of the display panel structure 110 is shielded by the light shield SRa, so that light leakage phenomenon may be prevented.

The mold frame 130 may include a support upper surface 130a supporting the display panel structure 110. An adhesive member 135a is disposed on the support upper surface 130a so that the display panel structure 110 may be adhered to the support upper surface 130a of the mold frame 130.

The adhesive member 135a may overlap the light shield SRa formed on the first surface 112a of the lower substrate 112. The adhesive member 135a may directly contact the light shield SRa. The light shield SRa may include a first portion contacting the adhesive member 135a, and a second portion. The second portion may be a remaining portion of the light shield SRa except for the first portion. The second portion of the light shield SRa may overlap the optical sheets 145, 146, 147 and the light guide plate 142. The adhesive member 135a may contact the first surface 112a of the lower substrate 112 on which the light shield SRa is formed, and may not contact the optical sheets 145, 146, 147.

According to the inventive concept, a liquid crystal display device includes a display panel structure, and a back light unit supplying light to the display panel structure. A light shield shielding some of light supplied from the back light unit may be formed on edge portions of the display panel structure. The light shield minimizes light leakage phenomenon of the liquid crystal display device so that a high reliability liquid crystal display device may be provided.

The above-disclosed subject matter is to be considered illustrative and not restrictive, and the appended claims are intended to cover all such modifications, enhancements, and other embodiments, which fall within the true spirit and scope of the inventive concept. Thus, to the maximum extent allowed by law, the scope of the inventive concept is to be determined by the broadest permissible interpretation of the following claims and their equivalents, and shall not be restricted or limited by the foregoing detailed description.

What is claimed is:

1. A liquid crystal display device comprising:
a display panel structure; and
a backlight unit configured to supply light to the display panel structure,
wherein the display panel structure comprises a light shield configured to shield a portion of the light supplied to the display panel structure, and the light shield is formed over an edge portion of the display panel structure.

2. The liquid crystal display device of claim 1, wherein the display panel structure comprises a polarizer, a lower substrate and an upper substrate that are stacked sequentially, and wherein the polarizer comprises the light shield.

3. The liquid crystal display device of claim 2, wherein the polarizer comprises a first surface facing the lower substrate, and a second surface opposing the first surface, and wherein the light shield is formed over the second surface of the polarizer.

4. The liquid crystal display device of claim 3, wherein the light shield is formed over an edge portion of the second surface of the polarizer.

5. The liquid crystal display device of claim 4, wherein the light shield is formed by black-printing the edge portion of the second surface of the polarizer.

6. The liquid crystal display device of claim 1, wherein the display panel structure comprises a polarizer, a lower substrate and an upper substrate that are stacked sequentially, and wherein the lower substrate comprises the light shield.

7. The liquid crystal display device of claim 6, wherein the lower substrate comprises a first surface facing the polarizer, and a second surface opposing the first surface, and wherein the light shield is formed over the first surface of the lower substrate.

8. The liquid crystal display device of claim 7, wherein the first surface of the lower substrate comprises a light shielding area where the light shield is formed, and a light transmission area surrounded by the light shielding area, and wherein the polarizer is disposed over the light transmission area of the first surface of the lower substrate.

9. The liquid crystal display device of claim 7, wherein the light shield is formed over an edge portion of the first surface of the lower substrate.

10. The liquid crystal display device of claim 9, wherein the light shield is formed by black-printing the edge portion of the first surface of the lower substrate.

11. The liquid crystal display device of claim 1, further comprising:
a mold frame comprising an upper surface supporting the display panel structure and surrounding the back light unit; and
an adhesive member disposed over the upper surface of the mold frame to adhere the mold frame to the display panel structure.

12. The liquid crystal display device of claim 11, wherein the back light unit comprises an optical sheet which is spaced apart from the adhesive member.

13. A liquid crystal display device comprising:
a display panel structure;
a mold frame comprising an upper surface supporting the display panel structure; and
an adhesive member disposed between the upper surface of the mold frame and the display panel structure to adhere the mold frame to the display panel structure,
wherein the display panel structure comprises a light shield contacting the adhesive member.

14. The liquid crystal display device of claim 13, further comprising a back light unit configured to supply light to the display panel structure and surrounded by the mold frame,
wherein the back light unit comprises a light source, and an optical sheet through which the light generated from the light source transmits, and wherein the adhesive member is spaced apart from the optical sheet.

15. The liquid crystal display device of claim 14, wherein the light shield comprise a first portion contacting the adhesive member, and a second portion overlapping the optical sheet.

16. The liquid crystal display device of claim 15, wherein the second portion does not contact the adhesive member.

17. The liquid crystal display device of claim 13, wherein the display panel structure comprises a first polarizer, a second polarizer, and a thin film transistor substrate and a color filter substrate between the first polarizer and the second polarizer, and
wherein the light shield is formed over a surface of the first polarizer facing the upper surface of the mold frame, and the first polarizer is adhered to the mold frame by the adhesive member.

18. The liquid crystal display device of claim 13, wherein the display panel structure comprises a first polarizer, a second polarizer, and a thin film transistor substrate and a color filter substrate between the first polarizer and the second polarizer, and
the light shield is formed over a surface of the lower substrate facing the upper surface of the mold frame, and the lower substrate is adhered to the mold frame by the adhesive member.
